(19) United States
(12) Patent Application Publication
(10) Pub. No.: US 2022/0137647 A1
(43) Pub. Date: May 5, 2022

(54) SYSTEM AND METHOD FOR OPERATING A MOVABLE OBJECT BASED ON HUMAN BODY INDICATIONS

(71) Applicant: SZ DJI TECHNOLOGY CO., LTD., Shenzhen (CN)

(72) Inventors: Jie QIAN, Shenzhen (CN); Chuangjie REN, Shenzhen (CN)

(73) Assignee: SZ DJI TECHNOLOGY CO., LTD., Shenzhen (CN)

(21) Appl. No.: 17/575,864

(22) Filed: Jan. 14, 2022

Related U.S. Application Data
(63) Continuation of application No. PCT/CN2020/087533, filed on Apr. 28, 2020.

(51) Int. Cl. G05D 1/12; G06V 40/16; G06V 40/20; B64C 39/02; G05D 1/00; G06V 10/25; G06T 7/70; G05D 1/10; G06V 20/17; G06V 10/70; B64D 47/08

(52) U.S. Cl. CPC G05D 1/12; G06T 2210/12; G06V 40/28; G06V 40/172; B64C 39/024; G05D 1/0094; G06V 40/23; G05D 1/0038; G06V 10/25; G06T 7/70; G05D 1/101; G06V 20/17; G06V 10/70; B64D 47/08; G06T 2207/20081; G06T 2207/30201; G06T 2207/10032; B64C 2201/127; G06V 40/174

(57) ABSTRACT

Methods, apparatuses, and non-transitory computer-readable medium for operating a movable object, the method including obtaining image data based on one or more images captured by an imaging sensor on board the movable object. Each of the one or more images includes at least a portion of a first human body. The method also includes identifying a first indication of the first human body in a field of view of the imaging sensor based on the image data, and causing the movable object to operate in response to the identified first indication of the first human body in the field of view of the imaging sensor.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to operation of movable devices and, more particularly, to devices and methods for operating movable devices based on human body indications.

### BACKGROUND

Unmanned aerial vehicles (“UAVs”), sometimes referred to as “drones,” include pilotless aircraft of various sizes and configurations that can be remotely operated by a user and/or programmed for automated flight. UAVs can be equipped with cameras to capture images and videos for various purposes including, but not limited to, recreation, surveillance, sports, and aerial photography.

Conventionally, a user is required to use a secondary device in communication with a UAV, such as a controller or a mobile phone, to operate the UAV and a camera on-board the UAV. However, it may take the user extra effort and time to learn, practice, and master the controlling process. In addition, the user often gets distracted from an ongoing activity (e.g., a hike, a conference, a work-out, a festivity, etc.) as the user needs to transfer his or her attention to operation of the controller or the mobile phone to communicate with the UAV. As such, while UAVs are becoming more intelligent and powerful for performing various autonomous functions, users may be frustrated by a cumbersome experience and even discouraged from using UAVs as much as they would like to. As a result, users are not effectively taking full advantage of the UAV's intelligence and powerful functions, and are missing opportunities to timely record subject matter of interest with the camera on-board the UAV.

Therefore, there exists a need for an improved interface to operate UAVs and their on-board cameras, to improve user experience.

### SUMMARY

Consistent with embodiments of the present disclosure, a method is provided for operating a movable object. The method includes obtaining image data based on one or more images captured by an imaging sensor on board the movable object. Each of the one or more images includes at least a portion of a first human body. The method also includes identifying a first indication of the first human body in a field of view of the imaging sensor based on the image data. The method further includes causing the movable object to operate in response to the identified first indication of the first human body in the field of view of the imaging sensor.

There is also provided an apparatus configured to operate a movable object. The apparatus includes one or more processors, and memory coupled to the one or more processors and storing instructions that, when executed by the one or more processors, cause the apparatus to perform operations including obtaining image data based on one or more images captured by an imaging sensor on board the movable object. Each of the one or more images includes at least a portion of a first human body. The apparatus is also caused to perform operations including identifying a first indication of the first human body in a field of view of the imaging sensor based on the image data; and causing the movable object to operate in response to the identified first indication of the first human body in the field of view of the imaging sensor.

There is further provided a non-transitory computer-readable medium with instructions stored thereon, that when executed by a processor, cause the processor to perform operations comprising obtaining image data based on one or more images captured by an imaging sensor on board the movable object, each of the one or more images including at least a portion of a first human body; identifying a first indication of the first human body in a field of view of the imaging sensor based on the image data; and causing the movable object to operate in response to the identified first indication of the first human body in the field of view of the imaging sensor.

It is to be understood that both the foregoing general description and the following detailed description are exemplary and explanatory only and are not restrictive of the invention, as claimed. Other objects and features of the present invention will become apparent by a review of the specification, claims, and appended figures.

### BRIEF DESCRIPTION OF THE DRAWINGS

FIG. 1 shows an example environment for operating a movable object in accordance with embodiments of the present disclosure.

FIG. 2 shows an example block diagram of an apparatus configured in accordance with embodiments of the present disclosure.

FIG. 3 shows a flow diagram of an example process of operating a UAV in accordance with embodiments of the present disclosure.

FIG. 4A illustrates an example figure of a distribution of key physical points on a human body in accordance with embodiments of the present disclosure.

FIG. 4B illustrates example confidence maps of possible locations of key physical points in accordance with embodiments of the present disclosure.

FIG. 5 shows an example of operating a UAV via a body indication estimated based on one or more images captured by an imaging sensor on-board the movable object in accordance with embodiments of the present disclosure.

FIG. 6 shows an example of operating a UAV via a body indication estimated based on one or more images captured by an imaging device on-board the movable object in accordance with embodiments of the present disclosure.

FIG. 7 shows an example of operating a UAV via a body indication estimated based on one or more images captured by an imaging device on-board the movable object in accordance with embodiments of the present disclosure.

FIGS. 8A-8D show examples of using body indications estimated from one or more images to operate a UAV in accordance with embodiments of the present disclosure.

### DETAILED DESCRIPTION

The following detailed description refers to the accompanying drawings. Wherever possible, the same reference numbers refer to the same or similar parts. While several illustrative embodiments are described herein, modifications, adaptations and other implementations are possible. For example, substitutions, additions or modifications may be made to the components illustrated in the drawings. Accordingly, the following detailed description is not limited to the disclosed embodiments and examples. Instead, the proper scope is defined by the appended claims.

Consistent with embodiments of the present disclosure, there are provided a method and an apparatus for operating a UAV in accordance with human body indications. The human body indications may include static body poses and body movements. The human body indications may be recognized based on images captured by an imaging device on-board the UAV. By using body indications to operate the UAV, users can be more engaged in their own activities, while enjoying the UAV's functions.

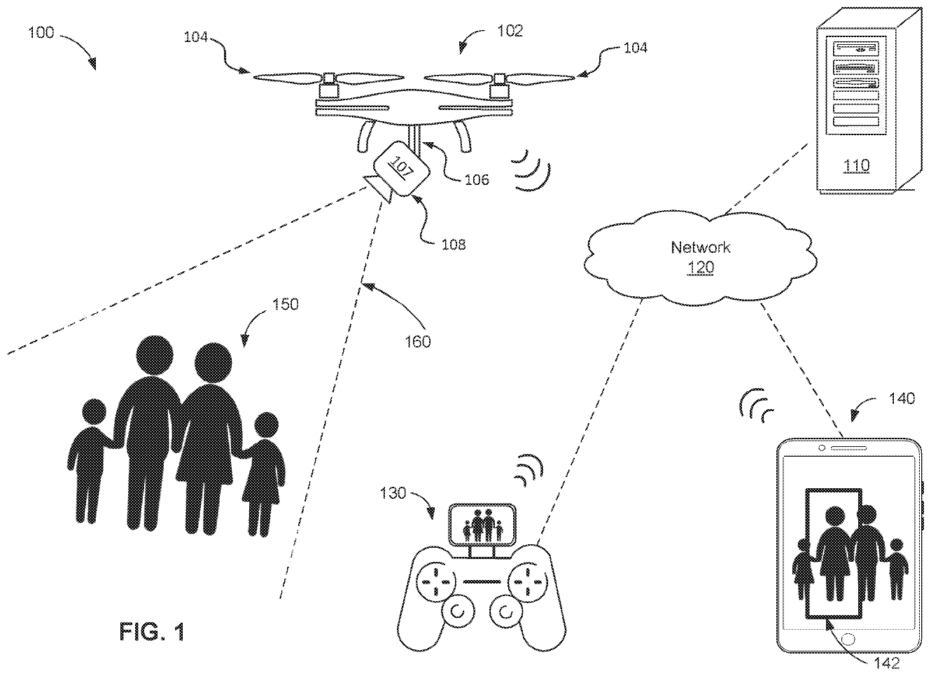

FIG. 1 shows an example environment 100 for operating a movable object, provided as an unmanned aerial vehicle (“UAV”) 102, in accordance with embodiments of the present disclosure. In some embodiments, environment 100 includes UAV 102 that is capable of communicatively connecting to one or more electronic devices including a remote control 130 (also referred to herein as a terminal 130), a mobile device 140, and a server 110 (e.g., cloud-based server) via a network 120 in order to exchange information with one another and/or other additional devices and systems. In some embodiments, network 120 may be any combination of wired and wireless local area network (LAN) and/or wide area network (WAN), such as an intranet, an extranet, and the internet. In some embodiments, network 120 is capable of providing communications between one or more electronic devices as discussed in the present disclosure. For example, UAV 102 is capable of transmitting data (e.g., image data and/or motion data) detected by one or more sensors on-board (e.g., an imaging sensor 107, and/or inertial measurement unit (IMU) sensors) in real-time during movement of UAV 102 to remote control 130, mobile device 140, and/or server 110 that are configured to process the data. In addition, the processed data and/or operation instructions can be communicated in real-time with each other among remote control 130, mobile device 140, and/or cloud-based server 110 via network 120. Further, operation instructions can be transmitted from remote control 130, mobile device 140, and/or cloud-based server 110 to movable object 102 in real-time to control the flight of UAV 102 and components thereof via any suitable communication techniques, such as local area network (LAN), wide area network (WAN) (e.g., the Internet), cloud environment, telecommunications network (e.g., 3G, 4G), WiFi, Bluetooth, radiofrequency (RF), infrared (IR), or any other communications technique.

While environment 100 is configured for operating a movable object provided as UAV 102, the movable object could instead be provided as any other suitable object, device, mechanism, system, or machine configured to travel on or within a suitable medium (e.g., a surface, air, water, rails, space, underground, etc.). The movable object may also be other types of movable object (e.g., wheeled objects, nautical objects, locomotive objects, other aerial objects, etc.). As discussed in the present disclosure, UAV 102 refers to an aerial device configured to be operated and/or controlled automatically or autonomously based on commands detected by one or more sensors (e.g., imaging sensor 107, an audio sensor, a ultrasonic sensor, and/or a motion sensor, etc.) on-board UAV 102 or via an electronic control system (e.g., with pre-programed instructions for controlling UAV 102). Alternatively or additionally, UAV 102 may be configured to be operated and/or controlled manually by an off-board operator (e.g., via remote control 130 or mobile device 140 as shown in FIG. 1).

UAV 102 includes one or more propulsion devices 104 and may be configured to carry a payload 108 (e.g., an imaging sensor). Payload 108 may be connected or attached to UAV 102 by a carrier 106, which may allow for one or more degrees of relative movement between payload 108 and UAV 102. Payload 108 may also be mounted directly to UAV 102 without carrier 106. In some embodiments, UAV 102 may also include a sensing system, a communication system, and an on-board controller in communication with the other components.

UAV 102 may include one or more (e.g., 1, 2, 3, 3, 4, 5, 10, 15, 20, etc.) propulsion devices 104 positioned at various locations (for example, top, sides, front, rear, and/or bottom of UAV 102) for propelling and steering UAV 102. Propulsion devices 104 are devices or systems operable to generate forces for sustaining controlled flight. Propulsion devices 104 may share or may each separately include or be operatively connected to a power source, such as a motor (e.g., an electric motor, hydraulic motor, pneumatic motor, etc.), an engine (e.g., an internal combustion engine, a turbine engine, etc.), a battery bank, etc., or a combination thereof. Each propulsion device 104 may also include one or more rotary components drivably connected to a power source (not shown) and configured to participate in the generation of forces for sustaining controlled flight. For instance, rotary components may include rotors, propellers, blades, nozzles, etc., which may be driven on or by a shaft, axle, wheel, hydraulic system, pneumatic system, or other component or system configured to transfer power from the power source. Propulsion devices 104 and/or rotary components may be adjustable (e.g., tiltable) with respect to each other and/or with respect to UAV 102. Alternatively, propulsion devices 104 and rotary components may have a fixed orientation with respect to each other and/or UAV 102. In some embodiments, each propulsion device 104 may be of the same type. In other embodiments, propulsion devices 104 may be of multiple different types. In some embodiments, all propulsion devices 104 may be controlled in concert (e.g., all at the same speed and/or angle). In other embodiments, one or more propulsion devices may be independently controlled with respect to, e.g., speed and/or angle.

Propulsion devices 104 may be configured to propel UAV 102 in one or more vertical and horizontal directions and to allow UAV 102 to rotate about one or more axes. That is, propulsion devices 104 may be configured to provide lift and/or thrust for creating and maintaining translational and rotational movements of UAV 102. For instance, propulsion devices 104 may be configured to enable UAV 102 to achieve and maintain desired altitudes, provide thrust for movement in all directions, and provide for steering of UAV 102. In some embodiments, propulsion devices 104 may enable UAV 102 to perform vertical takeoffs and landings (i.e., takeoff and landing without horizontal thrust). Propulsion devices 104 may be configured to enable movement of UAV 102 along and/or about multiple axes.

In some embodiments, payload 108 includes a sensory device. The sensory device may include devices for collecting or generating data or information, such as surveying, tracking, and capturing images or video of targets (e.g., objects, landscapes, subjects of photo or video shoots, etc.). The sensory device may include imaging sensor 107 configured to gather data that may be used to generate images. As disclosed herein, image data obtained from imaging sensor 107 may be processed and analyzed to obtain commands and instructions from one or more users to operate UAV 102 and/or imaging sensor 107. In some embodiments, imaging sensor 107 may include photographic cameras, video cameras, infrared imaging devices, ultraviolet imaging devices, x-ray devices, ultrasonic imaging devices, radar devices, etc. The sensory device may also or alternatively include devices for capturing audio data, such as microphones or ultrasound detectors. The sensory device may also or alternatively include other suitable sensors for capturing visual, audio, and/or electromagnetic signals.

Carrier 106 may include one or more devices configured to hold payload 108 and/or allow payload 108 to be adjusted (e.g., rotated) with respect to UAV 102. For example, carrier 106 may be a gimbal. Carrier 106 may be configured to allow payload 108 to be rotated about one or more axes, as described below. In some embodiments, carrier 106 may be configured to allow payload 108 to rotate about each axis by 360° to allow for greater control of the perspective of payload 108. In other embodiments, carrier 106 may limit the range of rotation of payload 108 to less than 360° (e.g., ≤270°, ≤210°, ≤180, ≤120°, ≤90°, ≤45°, ≤30°, ≤15°, etc.) about one or more of its axes.

Carrier 106 may include a frame assembly, one or more actuator members, and one or more carrier sensors. The frame assembly may be configured to couple payload 108 to UAV 102 and, in some embodiments, to allow payload 108 to move with respect to UAV 102. In some embodiments, the frame assembly may include one or more sub-frames or components movable with respect to each other. The actuator members (not shown) are configured to drive components of the frame assembly relative to each other to provide translational and/or rotational motion of payload 108 with respect to UAV 102. In other embodiments, actuator members may be configured to directly act on payload 108 to cause motion of payload 108 with respect to the frame assembly and UAV 102. Actuator members may be or may include suitable actuators and/or force transmission components. For example, actuator members may include electric motors configured to provide linear and/or rotational motion to components of the frame assembly and/or payload 108 in conjunction with axles, shafts, rails, belts, chains, gears, and/or other components.

The carrier sensors (not shown) may include devices configured to measure, sense, detect, or determine state information of carrier 106 and/or payload 108. State information may include positional information (e.g., relative location, orientation, attitude, linear displacement, angular displacement, etc.), velocity information (e.g., linear velocity, angular velocity, etc.), acceleration information (e.g., linear acceleration, angular acceleration, etc.), and or other information relating to movement control of carrier 106 or payload 108, either independently or with respect to UAV 102. The carrier sensors may include one or more types of suitable sensors, such as potentiometers, optical sensors, visions sensors, magnetic sensors, motion or rotation sensors (e.g., gyroscopes, accelerometers, inertial sensors, etc.). The carrier sensors may be associated with or attached to various components of carrier 106, such as components of the frame assembly or the actuator members, or to UAV 102. The carrier sensors may be configured to communicate data and information with the on-board controller of UAV 102 via a wired or wireless connection (e.g., RFID, Bluetooth, Wi-Fi, radio, cellular, etc.). Data and information generated by the carrier sensors and communicated to the on-board controller may be used by the on-board controller for further processing, such as for determining state information of UAV 102 and/or targets.

Carrier 106 may be coupled to UAV 102 via one or more damping elements (not shown) configured to reduce or eliminate undesired shock or other force transmissions to payload 108 from UAV 102. The damping elements may be active, passive, or hybrid (i.e., having active and passive characteristics). The damping elements may be formed of any suitable material or combinations of materials, including solids, liquids, and gases. Compressible or deformable materials, such as rubber, springs, gels, foams, and/or other materials may be used as the damping elements. The damping elements may function to isolate payload 108 from UAV 102 and/or dissipate force propagations from UAV 102 to payload 108. The damping elements may also include mechanisms or devices configured to provide damping effects, such as pistons, springs, hydraulics, pneumatics, dashpots, shock absorbers, and/or other devices or combinations thereof.

The sensing system of UAV 102 may include one or more on-board sensors (not shown) associated with one or more components or other systems. For instance, the sensing system may include sensors for determining positional information, velocity information, and acceleration information relating to UAV 102 and/or targets. In some embodiments, the sensing system may also include the above-described carrier sensors. Components of the sensing system may be configured to generate data and information for use (e.g., processed by the on-board controller or another device) in determining additional information about UAV 102, its components, and/or its targets. The sensing system may include one or more sensors for sensing one or more aspects of movement of UAV 102. For example, the sensing system may include sensory devices associated with payload 108 as discussed above and/or additional sensory devices, such as a positioning sensor for a positioning system (e.g., GPS, GLONASS, Galileo, Beidou, GAGAN, RTK, etc.), motion sensors, inertial sensors (e.g., IMU sensors, MIMU sensors, etc.), proximity sensors, imaging device 107, etc. The sensing system may also include sensors configured to provide data or information relating to the surrounding environment, such as weather information (e.g., temperature, pressure, humidity, etc.), lighting conditions (e.g., light-source frequencies), air constituents, or nearby obstacles (e.g., objects, structures, people, other vehicles, etc.).

The communication system of UAV 102 may be configured to enable communication of data, information, commands, and/or other types of signals between the on-board controller and off-board entities, such as remote control 130, mobile device 140 (e.g., a mobile phone), server 110 (e.g., a cloud-based server), or another suitable entity. The communication system may include one or more on-board components configured to send and/or receive signals, such as receivers, transmitter, or transceivers, that are configured for one-way or two-way communication. The on-board components of the communication system may be configured to communicate with off-board entities via one or more communication networks, such as radio, cellular, Bluetooth, Wi-Fi, RFID, and/or other types of communication networks usable to transmit signals indicative of data, information, commands, and/or other signals. For example, the communication system may be configured to enable communication between off-board devices for providing input for controlling UAV 102 during flight, such as remote control 130 and/or mobile device 140.

The on-board controller of UAV 102 may be configured to communicate with various devices on-board UAV 102, such as the communication system and the sensing system. The controller may also communicate with a positioning system (e.g., a global navigation satellite system, or GNSS) to receive data indicating the location of UAV 102. The on-board controller may communicate with various other types of devices, including a barometer, an inertial measurement unit (IMU), a transponder, or the like, to obtain positioning information and velocity information of UAV 102. The on-board controller may also provide control signals (e.g., in the form of pulsing or pulse width modulation signals) to one or more electronic speed controllers (ESCs), which may be configured to control one or more of propulsion devices 104. The on-board controller may thus control the movement of UAV 102 by controlling one or more electronic speed controllers.

The off-board devices, such as remote control 130 and/or mobile device 140, may be configured to receive input, such as input from a user (e.g., user manual input, user speech input, user gestures captured by imaging sensor 107 on-board UAV 102), and communicate signals indicative of the input to the controller. Based on the input from the user, the off-board device may be configured to generate corresponding signals indicative of one or more types of information, such as control data (e.g., signals) for moving or manipulating UAV 102 (e.g., via propulsion devices 104), payload 108, and/or carrier 106. The off-board device may also be configured to receive data and information from UAV 102, such as data collected by or associated with payload 108 and operational data relating to, for example, positional data, velocity data, acceleration data, sensory data, and other data and information relating to UAV 102, its components, and/or its surrounding environment. As discussed in the present disclosure, the off-board device may be remote control 130 with physical sticks, levers, switches, wearable apparatus, touchable display, and/or buttons configured to control flight parameters, and a display device configured to display image information captured by imaging sensor 107. The off-board device may also include mobile device 140 including a display screen or a touch screen, such as a smartphone or a tablet, with virtual controls for the same purposes, and may employ an application on a smartphone or a tablet, or a combination thereof. Further, the off-board device may include server system 110 communicatively coupled to a network 120 for communicating information with remote control 130, mobile device 140, and/or UAV 102. Server system 110 may be configured to perform one or more functionalities or sub-functionalities in addition to or in combination with remote control 130 and/or mobile device 140. The off-board device may include one or more communication devices, such as antennas or other devices configured to send and/or receive signals. The off-board device may also include one or more input devices configured to receive input from a user, generate an input signal communicable to the on-board controller of UAV 102 for processing by the controller to operate UAV 102. In addition to flight control inputs, the off-board device may be used to receive user inputs of other information, such as manual control settings, automated control settings, control assistance settings, and/or aerial photography settings. It is understood that different combinations or layouts of input devices for an off-board device are possible and within the scope of this disclosure.

The off-board device may also include a display device configured to display information, such as signals indicative of information or data relating to movements of UAV 102 and/or data (e.g., imaging data) captured by UAV 102 (e.g., in conjunction with payload 106). In some embodiments, the display device may be a multifunctional display device configured to display information as well as receive user input. In some embodiments, the off-board device may include an interactive graphical interface (GUI) for receiving one or more user inputs. In some embodiments, the off-board device, e.g., mobile device 140, may be configured to work in conjunction with a computer application (e.g., an “app”) to provide an interactive interface on the display device or multifunctional screen of any suitable electronic device (e.g., a cellular phone, a tablet, etc.) for displaying information received from UAV 102 and for receiving user inputs.

In some embodiments, the display device of remote control 130 or mobile device 140 may display one or more images received from UAV 102 (e.g., captured by imaging sensor 107 on-board UAV 102). In some embodiments, UAV 102 may also include a display device configured to display images captured by imaging sensor 107. The display device on remote control 130, mobile device 140, and/or on-board UAV 102, may also include interactive means, e.g., a touchscreen, for the user to identify or select a portion of the image of interest to the user. In some embodiments, the display device may be an integral component, e.g., attached or fixed, to the corresponding device. In other embodiments, display device may be electronically connectable to (and dis-connectable from) the corresponding device (e.g., via a connection port or a wireless communication link) and/or otherwise connectable to the corresponding device via a mounting device, such as by a clamping, clipping, clasping, hooking, adhering, or other type of mounting device. In some embodiments, the display device may be a display component of an electronic device, such as remote control 130, mobile device 140 (e.g., a cellular phone, a tablet, or a personal digital assistant), server system 110, a laptop computer, or other device.

In some embodiments, one or more electronic devices (e.g., UAV 102, server 110, remote control 130, or mobile device 140) as discussed with reference to FIG. 1 may have a memory and at least one processor and can be used to process image data obtained from one or more images captured by imaging sensor 107 on-board UAV 102 to identify body indication of an operator, including one or more stationary bodily pose, attitude, or position identified in one image, or body movements determined based on a plurality of images. In some embodiments, the memory and the processor(s) of the electronic device(s) are also configured to determine operation instructions corresponding to the identified body gestures of the operator to control UAV 102 and/or imaging sensor 107. The electronic device(s) are further configured to transmit (e.g., substantially in real time with the flight of UAV 102) the determined operation instructions to related controlling and propelling components of UAV 102 and/or imaging sensor 107 for corresponding control and operations.

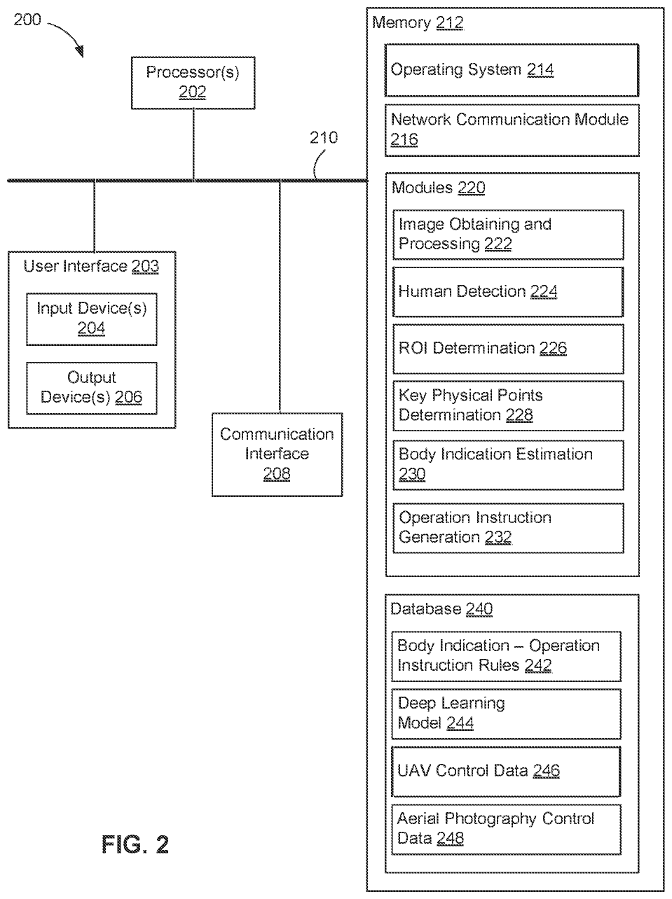

FIG. 2 shows an example block diagram of an apparatus 200 configured in accordance with embodiments of the present disclosure. In some embodiments, apparatus 200 can be any one of the electronic devices as discussed in FIG. 1, such as UAV 102, remote control 130, mobile device 140, or server 110. Apparatus 200 includes one or more processors 202 for executing modules, programs and/or instructions stored in a memory 212 and thereby performing predefined operations, one or more network or other communications interfaces 208, memory 212, and one or more communication buses 210 for interconnecting these components. Apparatus 200 may also include a user interface 203 comprising one or more input devices 204 (e.g., a keyboard, mouse, touchscreen) and one or more output devices 206 (e.g., a display or speaker).

Processors 202 may be any suitable hardware processor, such as an image processor, an image processing engine, an image-processing chip, a graphics-processor (GPU), a microprocessor, a micro-controller, a central processing unit (CPU), a network processor (NP), a digital signal processor (DSP), an application specific integrated circuit (ASIC), a field-programmable gate array (FPGA), or another programmable logic device, discrete gate or transistor logic device, discrete hardware component.

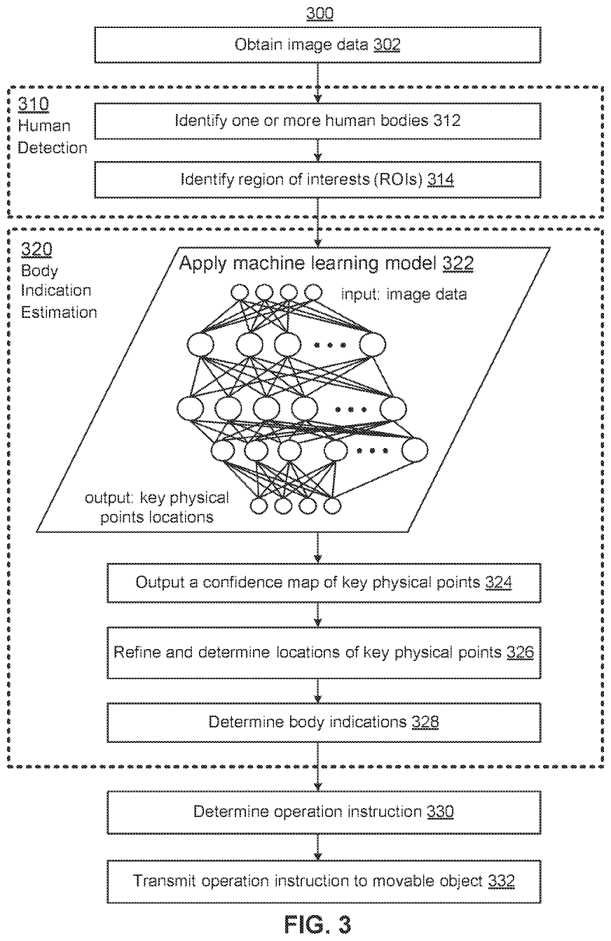

Memory 212 may include high-speed random access memory, such as DRAM, SRAM, or other random access solid state memory devices. In some implementations, memory 212 includes non-volatile memory, such as one or more magnetic disk storage devices, optical disk storage devices, flash memory devices, or other non-volatile solid state storage devices. In some implementations, memory 212 includes one or more storage devices remotely located from processor(s) 202. Memory 212, or alternatively one or more storage devices (e.g., one or more nonvolatile storage devices) within memory 212, includes a non-transitory computer readable storage medium. In some implementations, memory 212 or the computer readable storage medium of memory 212 stores one or more computer program instructions (e.g., modules) 220, and a database 240, or a subset thereof that are configured to perform one or more steps of a process 300 as discussed below with reference to FIG. 3. Memory 212 may also store images captured by imaging sensor 107, for processing by processor 202, operations instructions for controlling UAV 102 and imaging sensor 107, and/or the like.

In some embodiments, memory 212 of apparatus 200 may include an operating system 214 that includes procedures for handling various basic system services and for performing hardware dependent tasks. Apparatus 200 may further include a network communications module 216 that is used for connecting apparatus 200 to other electronic devices via communication network interfaces 208 and one or more communication networks 120 (wired or wireless), such as the Internet, other wide area networks, local area networks, metropolitan area networks, etc. as discussed with reference to FIG. 1.

FIG. 3 shows a flow diagram of an example process 300 of operating UAV 102 in accordance with embodiments of the present disclosure. For purposes of explanation and without limitation, process 300 may be performed by one or more modules 220 and database 240 of apparatus 200 shown in FIG. 2. For example, one or more steps of process 300 may be performed by software executing in UAV 102, remote control 130, mobile device 140, server 110, or combinations thereof.

In step 302, image data is obtained and processed by an image obtaining and processing module 222 of apparatus 200 shown in FIG. 2. In some embodiments, image data may be associated with one or more images or video footage (e.g., including a sequence of image frames) captured by imaging sensor 107 on-board UAV 102 as shown in FIG. 1. Imaging sensor 107 may be used to capture images of an ambient environment, which may include one or more people 150, as shown in FIG. 1, or a portion of a person (e.g., a face, a hand, etc.) and/or objects (e.g., a tree, a landmark, etc.). In some embodiments, the captured images may be transmitted to image obtaining and processing module 222 on-board UAV 102 for processing the image data. In some embodiments, the captured images may be transmitted from UAV 102 to image obtaining and processing module 222 in remote control 130, movable device 140, or server 110 via network 120 or other suitable communication technique as discussed in the present disclosure.

In some embodiments, the images or video footage captured by imaging sensor 107 may be in a data format requiring further processing. For example, data obtained from imaging sensor 107 may need to be converted to a displayable format before a visual representation thereof may be generated. In another example, data obtained for imaging sensor 107 may need to be converted to a format including numerical information that can be applied to a machine learning model for determining a body indication, such as a body gesture or movement or a body pose, of a person included in the captured image. In some embodiments, image obtaining and processing module 222 may process the captured images or video footage into a suitable format for visual representation (e.g., as shown on a display device of remote control 130 or mobile device 140 in FIG. 1) and/or for data analysis using machine learning models. For example, image obtaining and processing module 222 may generate a visual representation in accordance with a field of view 160 of UAV 102 as shown in FIG. 1, and the visual representation can be transmitted to a display device associated with remote control 130, mobile device 140, UAV 102, or server 110 for display.

Process 300 proceeds to a sub-process 310 to perform human detection in the captured image(s). In some embodiments, visual representation processed by image obtaining and processing module 222 may be further processed using one or more image recognition or computer vision processes to detect human bodies or portions thereof. In step 312 of sub-process 310, one or more human bodies (e.g., corresponding to people 150 in FIG. 1) or portions of human bodies in the captured images may be identified by a human detection module 224 of apparatus 200. Human detection module 224 may utilize various types of instruments and/or techniques to detect human bodies or portions of human bodies in captured images. For example, human detection module 224 may include software programs that use one or more methods for human detection, such as a Haar features based approach, histograms of an oriented gradients (HOG) based approach, a scale-invariant feature transform (SIFT) approach, and suitable deep convolutional neural network models for human detection.

In step 314 of sub-process 310, one or more region of interests (ROIs) may be identified in accordance with the identified human bodies in step 312 by a ROI determination module 226 of apparatus 200. In some embodiments, a ROI associated with a detected human body is predefined to be a rectangular area surrounding (e.g., enclosing) the detected human body and further enlarging (e.g., expanding) an area of the detected human body in the captured images, so that the ROI is capable of including and tracking various human poses and gestures performed by the corresponding human body, such as extending or upholding one's arms, jumping, etc. For example, the ROI may be predefined to be 2, 3, 4, or 5 times the area of the detected human body in the captured images (e.g., ROI=h (height of the person in the image)×w (width of the person in the image)×3). Information associated with the rectangular boundary surrounding the identified ROIs in step 314 may be sent from ROI determination module 226 to the display device that displays the view of imaging sensor 107 as discussed in step 302. For example, as shown in FIG. 1, a rectangular boundary 142 surrounding the ROI (e.g., also referred to as “bounding box 142”) is visually presented on the display device. In some other examples, a plurality of bounding boxes can be visually presented to surround a plurality of human bodies (e.g., all human bodies in the view, or some that are within a predefined range) detected (e.g., in real-time or off real-time) in the view of imaging sensor 107. In some embodiments, bounding boxes may be initially displayed for all detected human bodies in the view, then after one or more operators are identified and designated (e.g., via detecting predefined body indications), only the designated operator(s) are surrounded with bounding boxes on the display device. In some embodiments, data associated with identified ROIs in step 314 may be transmitted from ROI determination module 226 to corresponding module(s) configured to perform body indication estimation in a sub-process 320.

Process 300 proceeds to sub-process 320 to perform body indication estimation (e.g., pose estimation and gesture estimation) in the captured images. As discussed in the present disclosure, body indication may include a body movement (e.g., a body gesture) identified based on a plurality of images. For example, the body movement may include at least one of a hand movement, a finger movement, a palm movement, a facial expression, a head movement, an arm movement, a leg movement, and a torso movement. Body indication may also include a body pose associated with a stationary bodily attitude or position of at least a portion of the human body identified based on one image.

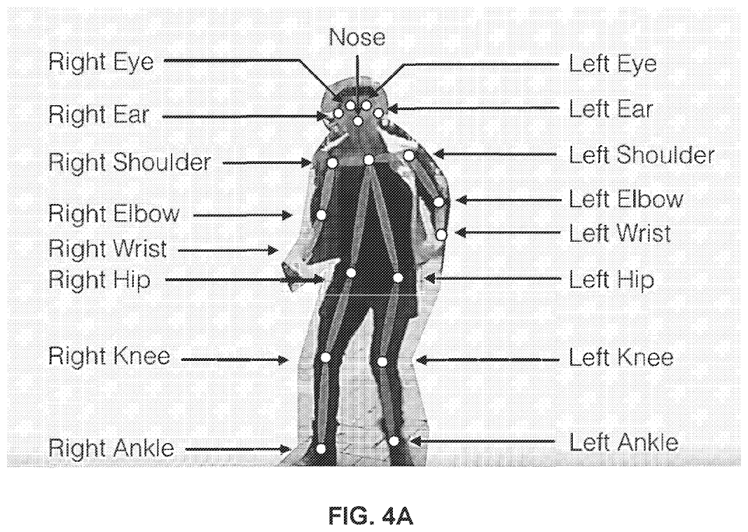

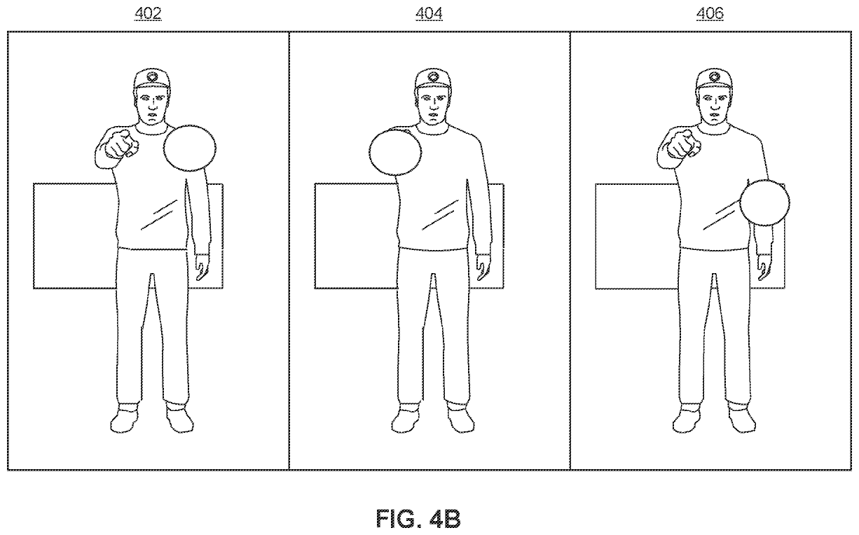

In step 322 of sub-process 320, the ROI data identified in step 314 is input to a machine learning model (e.g., stored in database 240, FIG. 2) by a key physical points determination module 228 of apparatus 200. FIG. 4A illustrates an example figure of a distribution of key physical points on a human body. Body indication estimation may include predicting locations of a plurality of preselected human key physical points (e.g., joints and landmarks), such as nose, left and right eyes, left and right ears, left and right shoulders, left and right elbows, left and right wrists, left and hips, left and right knees, and left and right ankles, etc. as illustrated in FIG. 4A. The locations of the key physical points may be predicted using any suitable deep convolutional neural network models. The predicted locations of the key physical points may include 2D locations (e.g., (x,y) coordinates) or 3D locations (e.g., (x,y,z) coordinates) of the key physical points. For example, as shown in step 322 of FIG. 3, an input to the machine learning model (e.g., a deep learning model) may include image data of the identified ROIs in step 314, an output of the machine learning model may include coordinates representing locations of the key physical points, and a plurality of hidden layers between the input and output layers. Prior to applying the deep learning model to determine human body indication for operating UAV 102, the deep learning model may be trained and tested using training data including image data of various human body poses and gestures and the label data of the corresponding body poses and gestures. A trained deep learning model 244 may be stored in database 240 of apparatus 200.

In step 324, a confidence map for the predicted key physical points is generated (e.g., by key physical points determination module 228). In step 322, one or more possible locations of each key physical point may be predicted using the deep learning model and assigned with respective confidence scores. FIG. 4B illustrates example confidence maps of possible locations of key physical points of an imaged person. With reference to FIG. 4B, for example, a confidence map may be generated for each key physical point, such as a confidence map 402 for right shoulder, a confidence map 404 for left shoulder, and a confidence map 406 for right elbow as viewed in FIG. 4B. From the imaged person's viewpoint, confidence map 402 shows left shoulder, confidence map 404 shows right shoulder, and confidence map 406 shows left elbow. A confidence map may also be generated for a plurality of key physical points. A highlighted part (e.g., a circle) on each map corresponds to an area within which the corresponding key physical point may exist at high probability. The area of the highlighted part (e.g., the circle) may be predefined to be a certain percentage of the human body displayed in the image (e.g., a confidence region=h′×w′×k, where h′ is 0.25×h, w′ is 0.25×w, and k is a number of physical key points used in the current body indication estimation process). For example, k can be 8, corresponding to left and right shoulders, left and right hips, left and right knees, and left and right ankles.

For example, as viewed in FIG. 4B, the confidence maps show highlighted regions within which the right shoulder, the left shoulder, and the right elbow are respectively highly possible to locate when the imaged person (e.g., the operator as discussed in the present disclosure) is in a certain body gesture or pose (e.g., left shoulder, right shoulder, and left elbow from the imaged person's viewpoint as discussed herein above). The confidence map data may be transmitted to a display device associated with remote control 130, mobile device 140, UAV 102, or server 110 for display.

In step 326, locations of the key physical points on the confidence map data generated in step 324 are further refined and verified. The key physical points locations may be refined by using the deep learning model. The possible locations of a respective key physical point determined in step 324 may be verified to determine whether it is feasible for the respective key physical point to exist at a certain location. For example, if possible locations of a right elbow determined using the deep learning model are on the left arm, then it is determined that these are impossible locations for the right elbow and thus will be excluded from being considered to determine body indications in the following steps. In some embodiments, in step 326, the confidence map for all physical key points are taken into consideration together to improve the prediction accuracy and to exclude impossible locations based on impossible association (e.g., logical association and physical association) between two or more key physical points. For example, the distance between left and right hips may be within a normal range of average human being. Also, it may be impossible to extend both left and right feet forward while walking.

In step 328, body indications (e.g., body poses or body movements) are determined by a body indication estimation module 230 in accordance with the refined and verified locations of the key physical points. For example, the key physical points in one image may be connected to generate the body poses for one or more human bodies in the image. In another example, the key physical points in each of a plurality of images may be connected to determine a body pose for each image, and then the body poses for the same human body from a plurality of images are considered together in sequence to determine a body movement.

In step 330, operation instructions are determined by an operation instruction generation module 232 based on the body indications determined in step 328. The operation instructions may be generated in accordance with predefined criteria associated with the identified indications. In some embodiments, predefined relationships between human body indications and corresponding operation instructions (e.g., body indication—operation instruction rules 242 stored in memory 212) may be preset and used for operating UAV 102 and/or imaging sensor 107 on-board UAV 102. In some embodiments, body indications may be used as triggering instructions to operate UAV 102. Triggering instructions may include performing actions in response to detecting body indications that are predefined to be associated with the actions. In one example, waving arm(s) above shoulder(s) may be associated with designating the person as an operator. In another example, uplifting both arms may be associated with landing UAV 102 on the ground. In yet another example, detecting certain actions (e.g., jumping up, saying “cheese,” etc.) toward imaging sensor 107 may be associated with taking snapshot(s) or video of the person performing the actions. In yet another example, detecting certain hand gestures (e.g., finger snapping, hand waving, etc.) may be associated with automatically and autonomously adjusting one or more parameters of imaging sensor 107 to switch between different aerial photography modes (e.g., stored in UAV control data 246 and aerial photography control data 248). The aerial photography modes may include, but are not limited to, snapshot mode, short video mode, slow-motion video mode, “QuickShots” mode (which further including sub-modes such as flying UAV backward and upward with camera facing toward the identified operator, circling UAV around operator, automatically adjusting UAV and camera to take panorama view including an environment surrounding the operator, etc.). In some embodiments, with regard to triggering instructions, only body indication—operation instruction rules 242 are used, but characteristics (e.g., direction, magnitude, or speed) of human body indications are not particularly tracked to generate respective operation instructions with corresponding parameters (e.g., direction, magnitude, or speed of UAV command).

In some embodiments, body indications may be used as controlling instructions to control the operations of UAV 102. Controlling instructions may include instructions for controlling one or more parameters (e.g., flight direction, speed, distance, camera focal length, shutter speed, etc.) of UAV 102 and/or imaging sensor 107 in accordance with one or more characteristics (e.g., body movement direction, speed, distance, etc.) of the detected body indications. In some embodiments, one or more characteristics associated with the body indications are determined, and operation instructions may be generated in accordance with the determined one or more characteristics to operate UAV 102 and/or imaging sensor 107. For example, in accordance with determining a direction (e.g., up or down, etc.) to which the operator's finger is pointing, UAV 102 is controlled to fly toward the direction (e.g., flying up or down). UAV 102 may further be controlled to fly at a speed in accordance with a moving speed of the operator's finger. In another example, in accordance with determining a magnitude (e.g., distance, length, etc.) and/or a direction (e.g., inward or outward) of the user's finger gesture (e.g., a pinch, a finger swipe), imaging device 107 is controlled to zoom in or zoom out proportionally to the detected direction and magnitude of the gesture. Different from triggering instructions, characteristics of controlling instructions (e.g., direction, magnitude, or speed) of human body indications are tracked to generate respective operation instructions with corresponding parameters (e.g., direction, magnitude, or speed of UAV command).

In some embodiments, body indications detected from a plurality of users may be used to operate UAV 102 and imaging sensor 107 during a group activity. For example, a plurality of users performing certain actions toward imaging sensor 107 (e.g., saying “cheese” toward imaging sensor 107 by their facial expressions, jumping up together, rolling on the ground, making certain hand gestures, such as “V” gesture or frame gesture, toward imaging sensor 107, etc.) may be associated with controlling imaging sensor 107 to take a snapshot, to start filming a video, or to start filming a slow motion video of the plurality of users.

In step 332, operation instructions determined in step 330 may be transmitted to the on-board controller of UAV 102 via any suitable communication networks, as discussed in the present disclosure. The corresponding modules of apparatus 200, such as body indication estimation module 230 and/or operation instruction generation module 232, may report recognized body indication and/or determined operation instruction to the on-board controller of UAV 102. The on-board controller can control various actions of UAV 102 (e.g., taking off or landing, ascending or descending, etc.), adjust the flight path of UAV 102 (e.g., hovering above a user), and control imaging sensor 107 (e.g., changing an aerial photography mode, zooming in or out, taking a snapshot, shooting a video, etc.). The operation instructions may be used to generate controlling commands to adjust parameters of propulsion devices 104, carrier 106, and imaging sensor 107, separately or in combination, so as to perform operations in accordance with the body indications of the operator. In some embodiments, operation instructions determined based on the operator's body indications may be first examined by the on-board controller of UAV 102 to determine whether it is safe (e.g., not at risk of colliding with an object in the surrounding environment, etc.) to perform the corresponding operations.

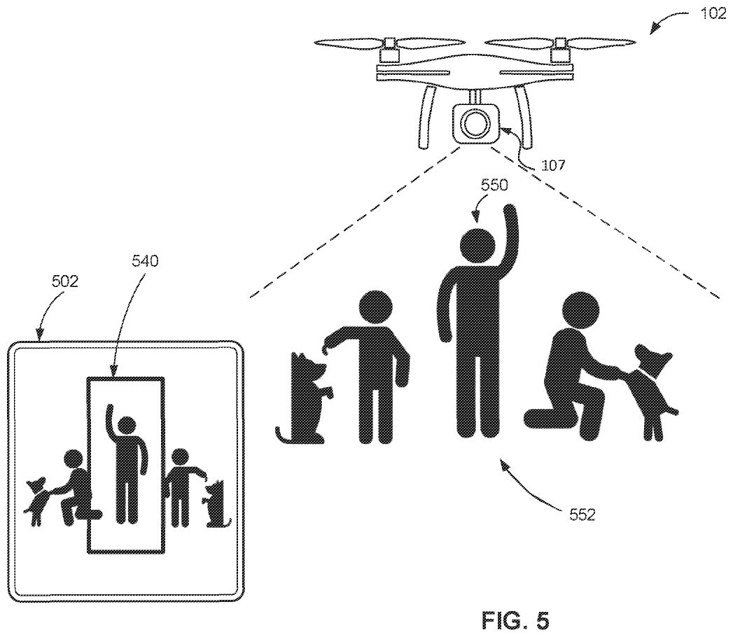

FIG. 5 shows an example of operating UAV 102 via a body indication estimated based on one or more images captured by imaging sensor 107 of UAV 102 in accordance with embodiments of the present disclosure. As shown in FIG. 5, a person 550 among a plurality of people and objects 552 within the field of view of imaging sensor 107 lifts one arm above his shoulder and waves at imaging sensor 107. One or more images including the plurality of people and objects 552 may be captured by imaging sensor 107 and the image data may be provided to apparatus 200 (e.g., mobile device 140, remote control 130, UAV 102, or server 110, FIG. 1). As discussed herein, one or more human bodies may be detected in the captured images, and corresponding ROIs may be obtained corresponding to the detected human bodies. The detected human bodies may be highlighted by bounding boxes on a display device 502 (e.g., associated with mobile device 140, remote control 130, UAV 102, or server 110, FIG. 1). The image data of ROIs may be processed using deep learning models (e.g., deep learning model 244, FIG. 2) to determine positions of key physical points on respective human bodies. Corresponding body indications (e.g., body poses or gestures) of respective human bodies can be determined. When a body indication of a person is determined to be associated with an operator designation (e.g., based on predetermined body indication—operation instruction rules 242), this person is designated as the operator.

For example, as shown in FIG. 5, it may be determined that, among the plurality of people and objects 552, person 550 is waving his arm over the shoulder. According to a predetermined relationship stored in body indication—operation instruction rules 242, an operation instruction of designating person 550 as an operator who controls UAV 102 may be determined. In response to designating person 550 as the operator, operator 550 will remain selected (e.g., the operator being placed at a center of the camera view, remain in focus, and surrounded by a bounding box 540 in the displayed image to visually indicate the operator identity), or automatically tracked by UAV 102 and imaging sensor 107 through suitable tracking algorithm. After designating the operator, subsequent body poses or body movements of person 550 will be tracked in the view of imaging sensor 107 for controlling UAV 102. Even though other people in the view are doing all types of body poses or movements (e.g., lifting upper arm to instruct a dog to stand, or holding palms of a dog to play with the dog), their body indications will not be tracked or recognized as operation commands to control UAV 102. Alternatively or additionally, a person captured by imaging device 107 in the field of view may be identified (e.g., through facial recognition performed on the captured image) as a registered user and designated as the operator of UAV 102.

In some embodiments, prior to causing UAV 102 to operate, it is further confirmed whether person 550 is intended to operate UAV 102 using body poses or gestures. For example, imaging sensor 107 may capture person 550 doing unconscious poses or gestures (e.g., scratching one's head, arm, face, etc.) or conscious poses or gestures (e.g., pointing to an object to show to a friend) that are not intended for operating UAV 102. In order to verify that the detected and recognized body indications are truly intended to instruct UAV 102 to perform the corresponding operations, some other key physical points are further examined in conjunction with the key physical points used to determine body indications. For example, in addition to determining that person 550 is waving his arm above his shoulder, his eyes and/or face are also tracked to determine whether he is facing toward imaging sensor 107. If person 550 is facing toward and/or staring at imaging sensor 107 while waiving his arm above his shoulder, it is confirmed that he intends operate UAV 102 using body indications. In another example, prior to instructing UAV 102 to perform corresponding operations, the on-board controller may wait a predefined short time period, such as 1 second or 2 second, to see whether person 550 still engages in the detected body pose or gesture (e.g., waving arm above shoulder). If the detected body pose or gesture lasts longer than a predetermined threshold time period, UAV 102 then starts to perform the corresponding operations.

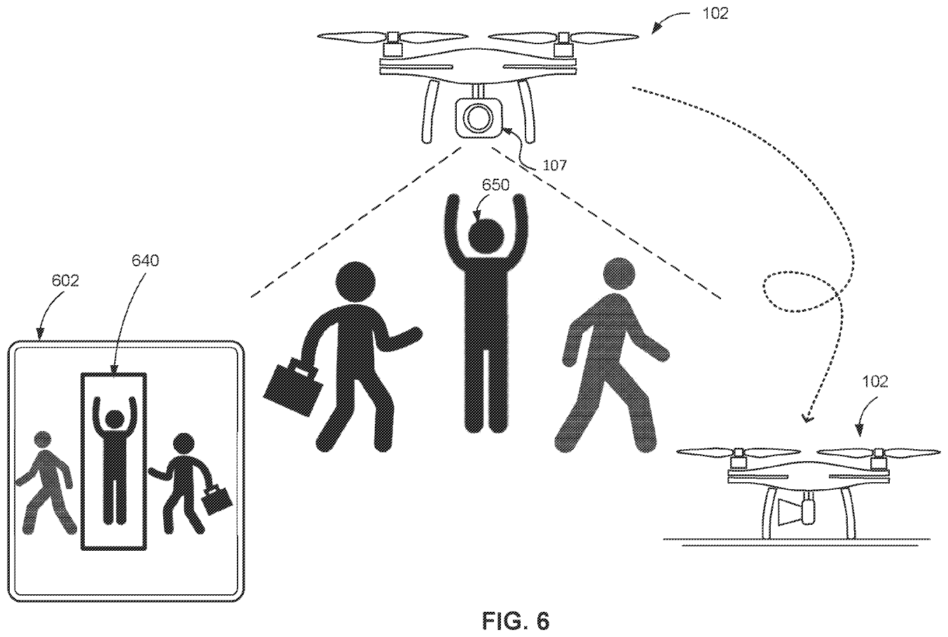

FIG. 6 shows an example of operating UAV 102 via a body indication estimated based on one or more images captured by imaging sensor 107 of UAV 102 in accordance with embodiments of the present disclosure. As shown in FIG. 6, a person 650 may be previously designated as an operator of UAV 102, as indicated by a surrounding bounding box 640 on a visual representation displayed on a display device 602. It may be detected and determined that person 650 lifted both arms above his shoulder. According to a predetermined criterion stored in body indication—operation instruction rules 242, an operation instruction of automatically and autonomously landing UAV 102 may be generated and transmitted to UAV 102. In some embodiments, it may further be confirmed whether operator 650 truly intended to control UAV 102 using his body language. In response to determining that operator 650 intended to control UAV 102 using his body indication, UAV 102 adjusts its controlling parameters to automatically land on the ground, as illustrated in FIG. 6.

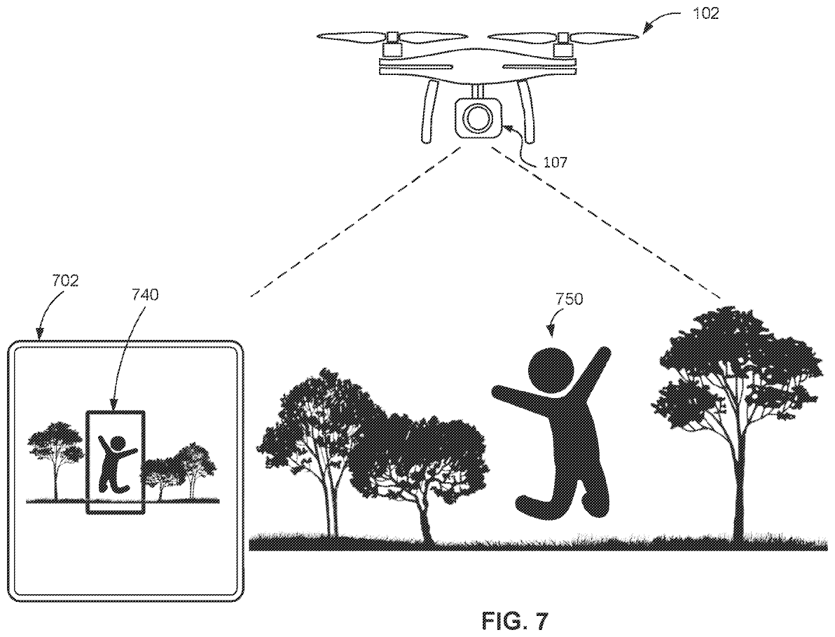

FIG. 7 shows an example of operating UAV 102 via a body indication estimated based on one or more images captured by imaging sensor 107 of UAV 102 in accordance with embodiments of the present disclosure. As shown in FIG. 7, a person 750 may be previously designated as an operator of UAV 102, as indicated by a surrounding bounding box 740 on a visual representation displayed on a display device 702. It may be determined that person 750 intended to take a jumping photo, in response to detecting and determining that person 750 jumped in front of imaging sensor 107. In response, an operation instruction of taking a snapshot or a short video of person 750 jumping in the air may be generated and transmitted to control imaging device 107. Corresponding parameters, e.g., focal length, shutter speed, ISO, etc., may be automatically adjusted for imaging sensor 107 to take the snapshot(s) or video.

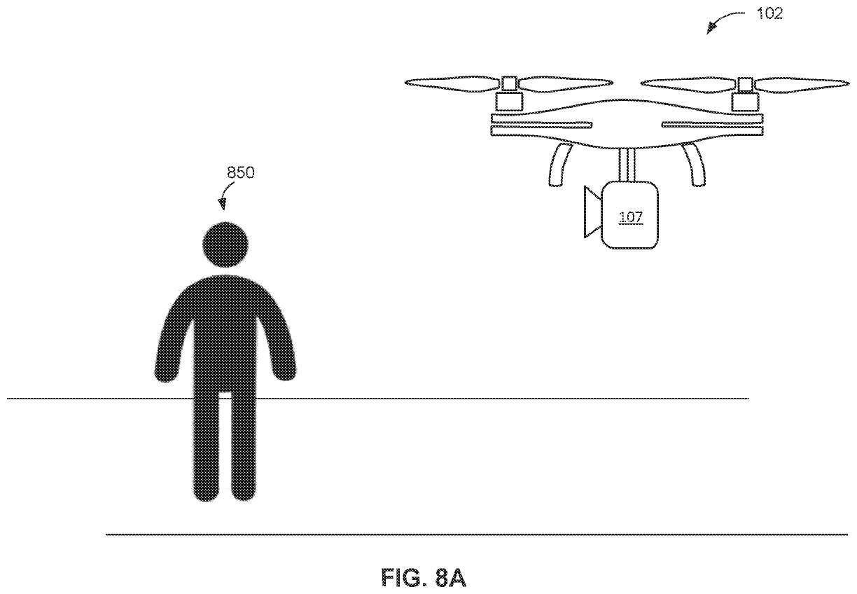

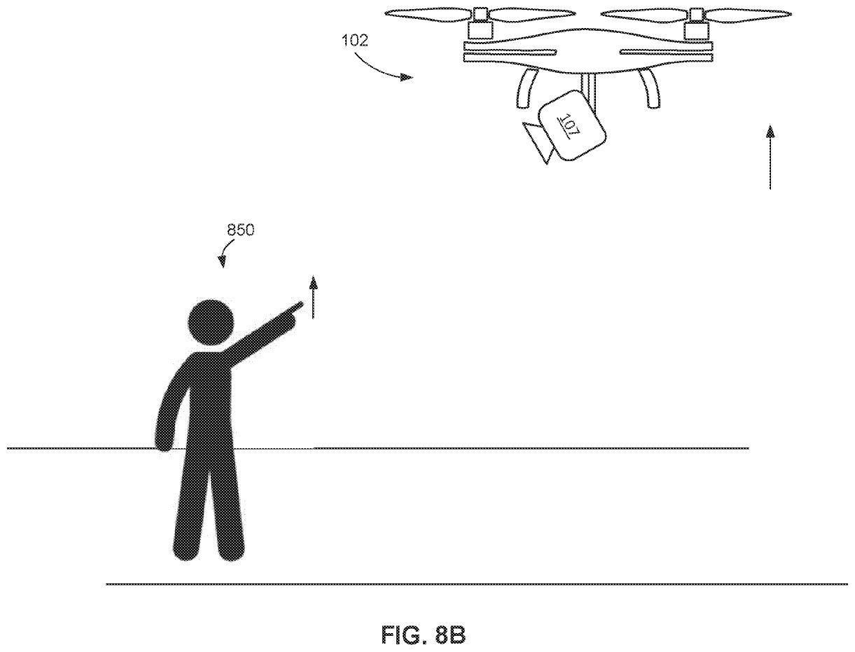

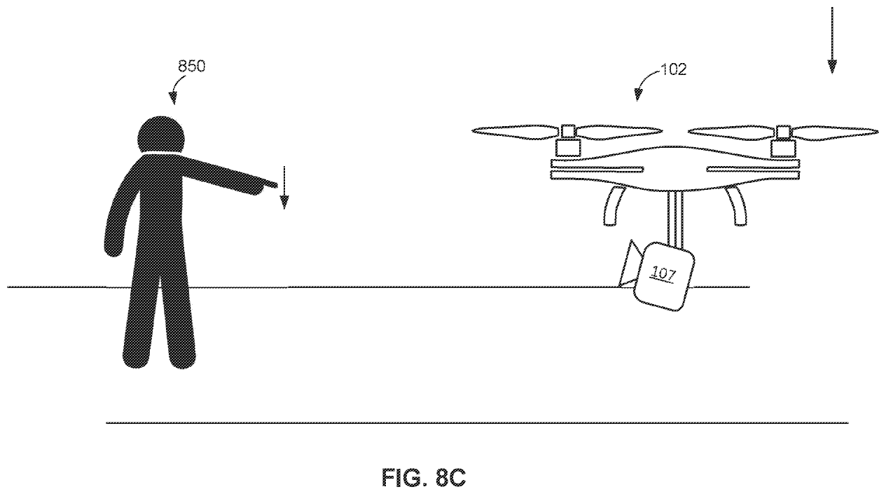

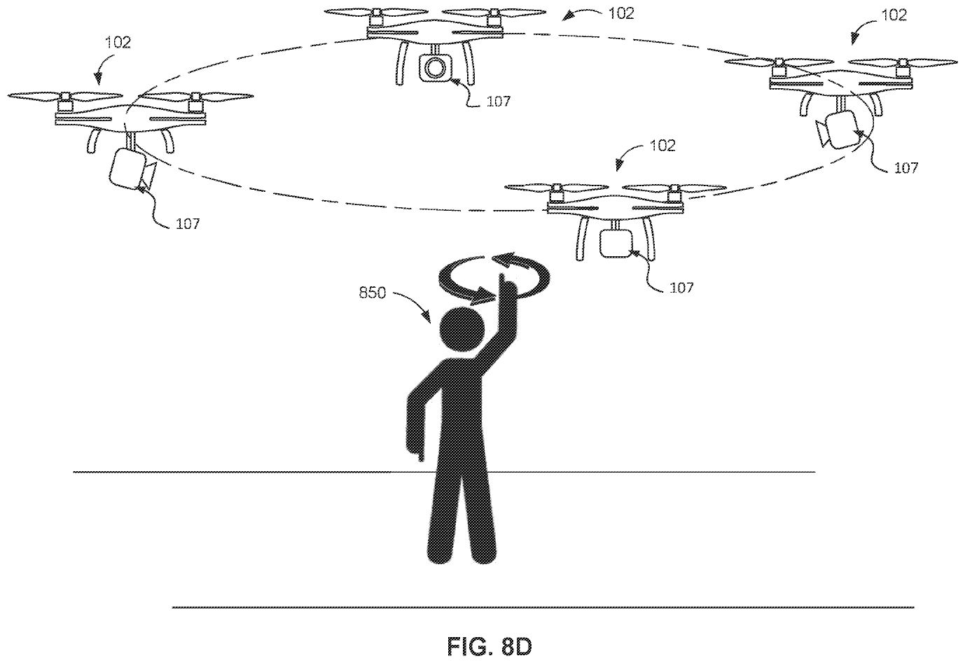

FIGS. 8A-8D show examples of operating UAV 102 via body indications estimated based on one or more images captured by imaging sensor 107 of UAV 102 in accordance with embodiments of the present disclosure. As shown in FIG. 8A, a person 850 in the view of imaging sensor 107 may be previously designated as an operator. As imaging sensor 107 faces toward operator 850, operator 850 may be tracked to detect body poses or movements that may be used to operate UAV 102. As shown in FIG. 8B, when it is detected and determined that operator 850 is pointing upward and moving his finger upward, UAV 102 may ascend at a speed and for a distance proportional to the moving speed and distance of the finger gesture of operator 850. Meanwhile, imaging sensor 107 is automatically adjusted to keep facing toward operator 850. Similarly, as shown in FIG. 8C, when it is detected and determined that operator 850 is pointing downward and moving his finger downward, UAV 102 may descend at a speed and for a distance proportional to the moving speed and distance of the finger gesture of operator 850. Imaging sensor 107 may be automatically adjusted to keep facing toward operator 850. Operator 850 may point in any other direction to instruct UAV 102 to fly toward the corresponding direction while maintaining imaging sensor 107 facing toward operator 850. For example, as shown in FIG. 8D, operator 850 may point his finger upward while circling his finger above his head. In response, UAV 102 may circle in the air above operator 850. The circling diameter of UAV 102 may be proportional to the magnitude of the operator's finger circling motion. During circling of UAV 102, imaging sensor 107 may be automatically adjusted to face toward operator 850. For example, UAV 102 may automatically track operator 850 by positioning UAV 102, carrier 106, and payload 108 to place operator 850 at a relatively fixed position (e.g., approximately the center) in the view of imaging sensor 107). Based on the state information of operator 850 (e.g., positional and/or motion information) determined from the captured images, and state information of UAV 102, carrier 106, and payload 108 (e.g., positional, velocity, orientation, angular information, etc.) obtained from the carrier sensors and IMU sensors, controlling information needed to adjust UAV 102, carrier 106, and payload 108 for automatically tracking operator 850 can be determined (e.g., by the on-board controller of UAV 102, remote control 130, mobile device 140, or server 110). The system can use any suitable object tracking algorithms and methods to generate the controlling information, such as kernel-based tracking, contour tracking, Kalman filter, particle filter, and/or suitable machine learning models. The controlling information may be transmitted to the on-board controller to send control signals to the carrier and payload tracking operator 850 while operator 850 moves. For example, the on-board controller can direct carrier 106 and/or payload 108 to rotate about different axes in response to the movement of operator 850.

Consistent with embodiments of the present disclosure, manual operation and body indication operation may be combined to control UAV 102. For example, a user may hold UAV 102 and manually select an intelligent auto-follow mode on a user interface of UAV 102. The user may then place UAV 102 on the ground. UAV 102 will automatically take off after self-checking and determining that the surrounding environment is safe. Then, an operator may be identified via detecting a person performing a predetermined body indication (e.g., as discussed with reference to FIG. 5), or via recognizing a pre-registered user (e.g., by facial expression), or via selecting a first detected human appearing within a predefined range from imaging sensor 107. Imaging sensor 107 may further track the operator's body poses and movements for further operating instructions. For example, imaging sensor 107 may automatically zoom in or out its camera view in accordance with detecting operator's finger pinching inward or outward. Imaging sensor 107 may adjust its optical and electrical parameters to take slow-motion video in response to detecting the operator doing a certain activity, such as jumping while skateboarding. As discussed in the present disclosure, the operator can also use gestures to change flying parameters of UAV 102, such as flying direction, angle, speed, height, or to automatically stop following and return. For example, for the UAV 102 to return, UAV 102 may slowly approach the operator or a predetermined location for return, and find a substantially flat area on the ground to land.

In another example, body indications may be used to instruct imaging sensor 107 to perform various automatic aerial photography. For example, an operator may hold UAV 102 and manually select a mode for taking quick and short videos on a user interface of UAV 102. The operator may then place UAV 102 on the ground. UAV 102 will automatically take off after self-checking and determining that the surrounding environment is safe. Then, the operator who operates UAV 102 via body indications may be recognized using any suitable methods as discussed in the present disclosure. In some embodiments, a group of people may be detected in the view of imaging device 107, and group images or videos may be captured by imaging sensor 107 in response to detecting and determining predefined body poses or gestures (e.g., “V” hand gestures, “cheese” facial expressions, etc.) of the group of people in the view. UAV 102 may engage in various preprogramed aerial photography modes, and the operator's body or finger gesture may be used to switch between the different aerial photography modes. In some embodiments, prior to or during imaging sensor 107 capturing a video or a sequence of images, imaging sensor 107 may stop operating when UAV 102 detects an obstacle that interferes with the view of imaging sensor 107 or poses a risk to the safety of UAV 102. After finishing capturing the video or images, UAV 102 may automatically return to and land at the starting point.

In some embodiments, the steps of process 300 may be performed by more than one electronic device, as shown in FIG. 1. For example, image data can be processed and human body detection 310 can be performed by one or more modules on-board UAV 102. Body indication estimation 320, including estimating key physical points locations and estimating body indications using deep learning models, can be performed by other entities (e.g., mobile device 140, server 110, or remote control 130) which may have greater computing powers. The various network communication channels discussed in the present disclosure are capable of handling real-time data transmission during the flight of UAV 102.

It is to be understood that the disclosed embodiments are not necessarily limited in their application to the details of construction and the arrangement of the components set forth in the following description and/or illustrated in the drawings and/or the examples. The disclosed embodiments are capable of variations, or of being practiced or carried out in various ways. The types of user control as discussed in the present disclosure can be equally applied to other types of movable objects or any suitable object, device, mechanism, system, or machine configured to travel on or within a suitable medium, such as a surface, air, water, rails, space, underground, etc.

It will be apparent to those skilled in the art that various modifications and variations can be made to the disclosed devices and systems. Other embodiments will be apparent to those skilled in the art from consideration of the specification and practice of the disclosed devices and systems. It is intended that the specification and examples be considered as exemplary only, with a true scope being indicated by the following claims and their equivalents.

1. A method for operating a movable object, comprising:
obtaining image data based on one or more images captured by an imaging sensor on board the movable object, each of the one or more images including at least a portion of a first human body;
identifying a first indication of the first human body in a field of view of the imaging sensor based on the image data; and
causing the movable object to operate in response to the identified first indication of the first human body in the field of view of the imaging sensor.

2. The method of claim 1, further comprising:
detecting one or more human bodies including the first human body in each of the one or more images; and
determining indications associated with the one or more human bodies respectively based on the one or more images.

3. The method of claim 2, further comprising:
determining that the first indication satisfies a predefined criterion; and
in accordance with determining that the first indication of the first human body satisfies the predefined criterion, determining the first human body is associated with an operator to operate the movable object.

4. The method of claim 2, further comprising:
determining that the first human body is associated with a registered user by performing facial recognition on the one or more images; and
in accordance with determining that the first human body is associated with the registered user, determining the registered user is an operator to operate the movable object.

5. The method of claim 2, wherein the indications associated with the one or more human bodies are determined by applying a machine learning model to the image data obtained from the one or more images.

6. The method of claim 2, wherein determining the indications associated with the one or more human bodies further comprises:
determining respective locations of a plurality of key physical points on each of the one or more human bodies.

7. The method of claim 6, further comprising:
causing display of a confidence map of the plurality of key physical points for at least one of the one or more human bodies on a display device.

8. The method of claim 2, further comprising:
causing display of one or more bounding boxes respectively surrounding the one or more detected human bodies on a display device.

9. The method of claim 2, further comprising:
determining that a plurality of indications associated with a plurality of human bodies satisfy predefined criteria, and causing the movable object to operate in response to the plurality of indications.

10. The method of claim 1, wherein causing the movable object to operate further comprises:
generating an operation instruction to operate the movable object in accordance with predefined criteria associated with the identified first indication.

11. The method of claim 1, further comprising:
in response to identifying the first indication of the first human body, causing the movable object and the imaging sensor to track the first human body in the field of view of the imaging sensor.

12. The method of claim 1, further comprising:
determining that the first indication of the first human body satisfies a predefined criterion, and causing display on a display device of a first bounding box surrounding the first human body.

13. The method of claim 1, further comprising:
determining that the first indication of the first human body satisfies a predefined criterion, and causing the movable object to autonomously land.

14. The method of claim 1, further comprising:
determining that the first indication of the first human body satisfies predefined criteria, and causing the imaging sensor to autonomously capture one or more images of the first human body.

15. The method of claim 1, further comprising:
determining that the first indication of the first human body satisfies predefined criteria, and causing autonomous adjustment of one or more parameters of the imaging sensor to change from a first photography mode to a second photography mode.

16. The method of claim 1, further comprising:
determining one or more characteristics associated with the first indication of the first human body; and
causing the movable object to operate in accordance with the determined one or more characteristics.

17. The method of claim 1, wherein the first indication of the first human body includes a body movement identified based on a plurality of images, the body movement including at least one of a hand movement, a finger movement, a palm movement, a facial expression, a head movement, an arm movement, a leg movement, or a torso movement.

18. The method of claim 1, wherein the first indication of the first human body includes a body pose associated with a stationary bodily attitude or position that is identified based on one image.

19. The method of claim 1, further comprising:
prior to causing the movable object to operate, confirming that the first indication of the first human body is intended to operate the movable object.

20. The method of claim 1, wherein the movable object is an unmanned aerial vehicle (UAV).

21.-60. (canceled)
